(19) United States
(12) Patent Application Publication
(10) Pub. No.: US 2009/0248398 A1
(43) Pub. Date: Oct. 1, 2009

(54) Vocal Alert Unit Having Automatic Situation Awareness

(75) Inventors: Moshe Aviran, Kochav Yair (IL); Alexander Zussman, Ashdod (IL)

Correspondence Address: OLIFF & BERRIDGE, PLC, P.O. BOX 320850, ALEXANDRIA, VA, 22320-4850, US

(73) Assignee: Elta Systems Ltd, Ashdod (IL)

(21) Appl. No.: 12/084,553

(22) PCT Filed: Sep. 13, 2006
(86) PCT No.: PCT/IL2006/001071

§ 371 Date: Jun. 24, 2008

(30) Foreign Application Priority Data
Nov. 3, 2005 (IL) 171771

(51) Int. Cl. G06F 17/27; G10L 15/00; G10L 13/08

(52) U.S. Cl. 704/9; 704/275; 704/260; 704/E15.001; 704/E13.001

(57) ABSTRACT

A system and method for instructing dynamic nodes in a dynamically changing mobile network how to maneuver. A receiver receives situation data indicative of a respective situation of each dynamic node in space and a situation unit coupled to the receiver determines the respective situation of each dynamic node. An analysis unit coupled to the situation unit analyzes the respective situation of each dynamic node in combination with specified criteria to generate respective situation awareness date for each dynamic node. A dynamic selector unit coupled to the analysis unit determines from the respective situation awareness data appropriate action to be performed by each node; and a communication unit coupled to the dynamic selector unit conveys to the respective dynamic node command data to permit rendering of a personalized command for informing the respective node of appropriate action to be carried out thereby.

### FIELD OF THE INVENTION

This invention relates to command, control, communication and intelligence systems, commonly abbreviated to C4I systems.

### BACKGROUND OF THE INVENTION

Command, control, communication and intelligence systems, be they civil, military, or paramilitary, such as take off or landing systems in airports, aircraft carriers, Airborne Warning and Control Systems (AWACS) and the like, require high concentration and fast response from the system operators. In an air traffic system, for example, the pilots do not see the complete picture that is seen by the air traffic controller, and so rely on the air traffic controller to whom they are responsible to review the complete aerial picture, typically obtained via radar, and to instruct the pilots under their direct responsibility how to maneuver. C4I systems are commonly used to control air or maritime craft but the present invention is applicable to any C4I system where a limited number of participants are directed by a controller and are dependent on the controller for carrying out commands responsive to situations that are apparent to the controller but not necessarily to the participants.

In such systems, commands are conventionally given vocally via radio communication. Again, to tale the example of an air traffic system, the system controller obtains a complete picture defining the environment in which the participating aircraft are maneuvering and which is continuously updated. For each pilot under his care, he visually examines the current frame and on identifying potentially hazardous situations, he determines and communicates what evasive action the respective pilot must take to maneuver out of harm. He must repeat the procedure for all other pilots under his care and this whole process must then be repeated for each successive frame of image data.

It is thus apparent that in an air traffic system, the controller must perform three essential tasks: first, he must analyze each current image frame and identify potentially hazardous situations; second he must determine what evasive action the pilot must take; and third he must communicate suitable commands to the pilot. All this must be done for each pilot under his care for each frame of image data. It is apparent that this is a highly stressful activity for the air traffic controller and all the more so the faster the environment changes and the more threats or other hazards are directed to a pilot. Thus, the nature of the environment, its expected rate of change, and the need to communicate different information vocally substantially simultaneously to a number of participants, impose an upper limit of the number of participants to whom a single controller can safely be responsible.

U.S. Pat. No. 4,428,052 (Robinson et al.) issued Jan. 24, 1984 and entitled “Navigational aid autopilot” discloses a marine navigational and autopilot apparatus having a controller which correlates information from sensors and instruments to form single communication signal for operator. In one embodiment, the controller is adapted to communicate a “Mayday” signal vocally in a language that is synthesized according to the likely predominant language of the recipient. The speech synthesis required to do this is not only limited, as would clearly be expected at the time this patent was filed, but is used to ease the burden on the recipient and not on a central controller who must convey different warning signals to multiple recipients.

WO 93/11443 (Leonard) published Jun. 10, 1993 and entitled “Method and apparatus for controlling vehicle movements” describes a vehicle dispatching controller for a taxi fleet supplying location data from onboard computers, transmitting to base, selecting a suitable vehicle at a base computer and transmitting command to a chosen vehicle. The onboard computer may be equipped with a voice synthesizer for giving verbal information. The vehicle dispatching controller aids the dispatcher in making a very rapid decision when selecting a cab to instruct for a specific journey, bearing in mind that typically the dispatcher will not be aware of all the determining factors and has insufficient time to weigh up all the relevant factors. This is aggravated by the fact that he has to spend much of his time in verbal communication with each driver as well as with potential fares.

Vehicle situation awareness defining the location of each vehicle is supplied to the vehicle, processed and conveyed to a base station at the dispatcher who uses the information in combination with information relating to the location of a requisitioned fare to determine which vehicle is best located to collect the fare. The situation data may comprise other factors such as vehicle occupancy, weather conditions, fuel level, and so on. The base station then conveys a command signal to the selected vehicle, which may control a printer in the taxi for printing instructions to the driver; or may be fed to a voice synthesizer for synthesizing vocal instructions.

In such a system situation awareness relates to the suitability of each vehicle separately and is communicated to the vehicle dispatcher who then makes as selection based on the location of the prospective fare. The system provides more comprehensive information to the dispatcher, making it easier to select the most suitable available vehicle; but it does not provide the dispatcher with the ability to communicate with a larger fleet of vehicles. Nor is such a system directed to assisting the participating vehicles to evade external threats.

U.S. Pat. No. 5,557,278 (Piccirillo et al.) published Sep. 17, 1996 discloses an airport integrated hazard response apparatus for monitoring the position of multiple objects in a predefined space. A tracking supervisor receives target data from a sensor, characterizes and tracks selected objects, and provides a target output having multiple features respective of the selected objects. A location supervisor characterizes and displays multiple features in the space, and provides a location output having the aforementioned features therein. A hazard monitoring supervisor detects and responds to a predetermined hazard condition, and provides a detectable notice of such hazard condition, responsive to the target output and the location output. Audible warning signals may be synthesized.

Such an apparatus can analyze surface object movements for indications of possible threats, and can automatically alert controllers to inadequate vehicle spacing, inappropriate or unauthorized movements or positioning within the airport area and its associated airspace, and even runway debris all of which constitute threats that must be monitored. The AIHR can track a preselected number of targets including aircraft on final approach, as well as those that are departing or landing, and objects, including aircraft, that are taxiing or stopped.

EP 1 190 408 (Simon et al.) published Mar. 27, 2002 discloses an automated air-traffic advisory system where vocal advisory messages are synthesized and broadcast to pilots, so as to avoid the need for an air traffic controller. Since the advisory messages are broadcast, it appears that they are conveyed to all aircraft within broadcast range and are not aircraft-specific. Moreover, the advisory messages alert the pilots of a threat, such as poor visibility, but not appear to suggest evasive action as would normally be conveyed on an individual aircraft basis by the air traffic controller.

None of these prior art references discloses a method and system for reducing the load on a controller so as to allow him to service a larger number of participants in a dynamically changing mobile network and to instruct participants how to maneuver in order to carry out a target mission or of evasive action they should perform to maneuver out of the path of perceived threats.

### SUMMARY OF THE INVENTION

It is therefore an object of the present invention to provide a method and system for reducing the load on a controller so as to allow him to service a larger number of dynamic nodes in a dynamically changing mobile network and to instruct dynamic nodes how to maneuver in order to carry out a target mission or of evasive action they should perform to maneuver out of the path of perceived threats.

This object is realized in accordance with a first aspect of the invention by a method for instructing dynamic nodes in a dynamically changing mobile network how to maneuver in order to carry out a target mission or of evasive action they should perform to maneuver out of a path of a perceived threat, said method comprising:

receiving situation data indicative of a respective situation of each dynamic node in space;

determining from said situation data the respective situation of each dynamic node;

analyzing the respective situation of each dynamic node in combination with specified criteria to generate respective situation awareness data for each dynamic node;

determining from the respective situation awareness data appropriate action to be performed by each node; and

conveying to the respective dynamic node command data to permit rendering of a personalized command for informing the respective node of appropriate action to be carried out thereby

According to a second aspect of the invention there is provided a system for instructing dynamic nodes in a dynamically changing mobile network how to maneuver in order to carry out a target mission or of evasive action they should perform to maneuver out of a path of a perceived threat, said system comprising:

a receiver for receiving situation data indicative of a respective situation of each dynamic node in space;

a situation unit coupled to the receiver for determining from said situation data the respective situation of each dynamic node;

an analysis unit coupled to the situation unit for analyzing the respective situation of each dynamic node in combination with specified criteria to generate respective situation awareness data for each dynamic node;

a dynamic selector unit coupled to the analysis unit for determining from the respective situation awareness data appropriate action to be performed by each node; and

a communication unit coupled to the dynamic selector unit for conveying to the respective dynamic node command data to permit rendering of a personalized command for informing the respective node of appropriate action to be carried out thereby.

### BRIEF DESCRIPTION OF THE DRAWINGS

In order to understand the invention and to see how it may be carried out in practice, a preferred embodiment of a vocal unit will now be described, by way of non-limiting example only, for use with an aircraft command, control, communication and intelligence system and with reference to the accompanying drawings, in which:

FIG. 1 is a block diagram showing the functionality of a vocal alert unit in accordance with an exemplary embodiment of the invention;

FIG. 2 is a block diagram showing in more detail the functionality of an aircraft command, control, communication and intelligence system employing the vocal alert unit depicted in FIG. 1;

FIG. 3 is a block diagram showing in more detail the functionality of a situation awareness objects data analysis unit used in the system shown in FIG. 2; and

FIG. 4 is a flow diagram showing the principal operations carried out by the system shown in FIGS. 1 and 2.

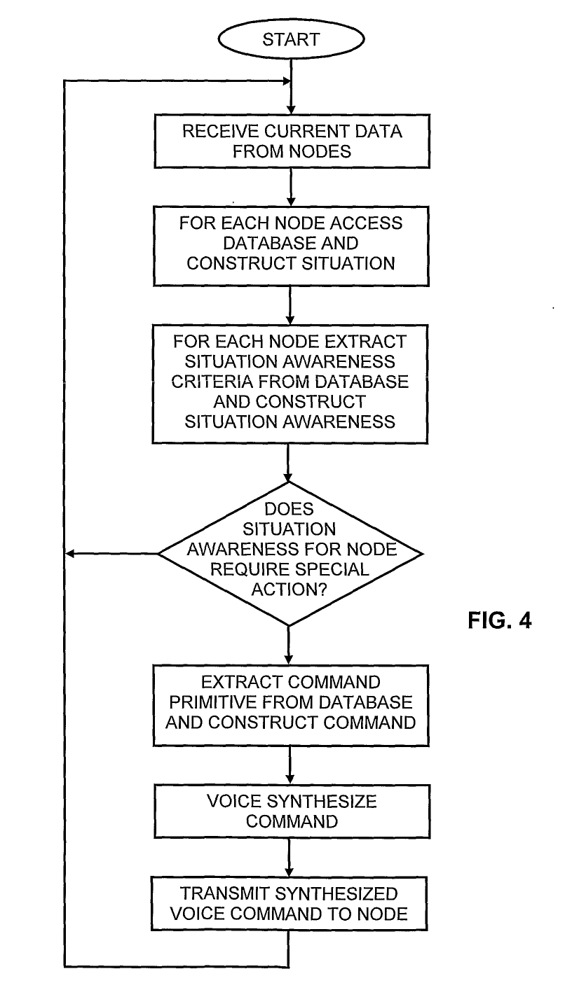

### DETAILED DESCRIPTION OF EXEMPLARY EMBODIMENTS

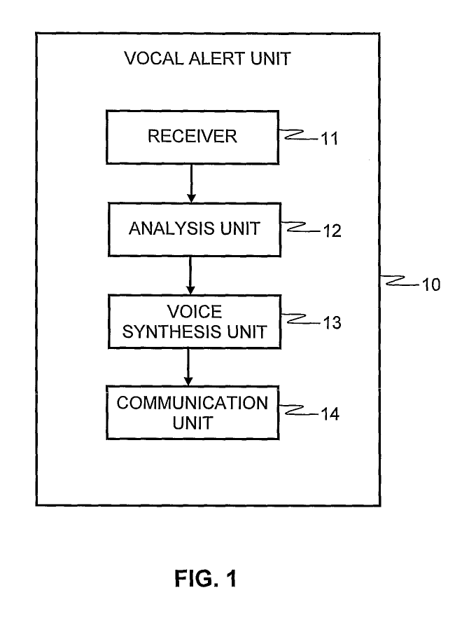

FIG. 1 is shows the functionality of a vocal alert unit 10 comprising a receiver 11 for receiving data depicting an instantaneous location of a respective node in space traversed by nodes. Nodes may be static or dynamic. For example, a static node may be a building or area the coordinates of whose boundaries are known and into which a dynamic node is not allowed to enter. Conditions may be associated with nodes that allow conditional situations to be determined. For example, a dynamic node may be flagged as “friendly” in which case it may be allowed to enter a specified area that is “closed” to dynamic nodes that are not flagged as “friendly”. In such manner, complex situations can be constructed and analyzed whereby information from each dynamic node is received and computed to construct situations for each node. The situations thus obtained are then analyzed based on stored conditions and other criteria to determine a situation awareness picture that effectively denotes whether special action must be taken.

In a typical scenario the receiver 11 is part of a radar unit of which constantly tracks participating aircraft and displays their locations on a radar screen. An analysis unit 12 coupled to the receiver analyzes the received data and determines for each node whether any change in current operation is called for. For example, the analysis unit 12 may determine for each node whether there are any perceived threats such as, for example, potential collisions; and, for each such threat, determines appropriate evasive action that should be performed by the threatened node. However, the invention is not limited to warning of impending threats, although clearly this is an important application. In other applications, a combat pilot on an intercept mission may be automatically directed by the system toward the target, even when the target is moving. Likewise, a civilian pilot can be directed during landing or takeoff. A voice synthesis unit 13 coupled to the analysis unit 12 translates alphanumeric data into verbal commands and transmits data representative thereof to the pilot being navigated via a communication unit 14 thereby conveying to the pilot command data indicative of the necessary evasive or other action.

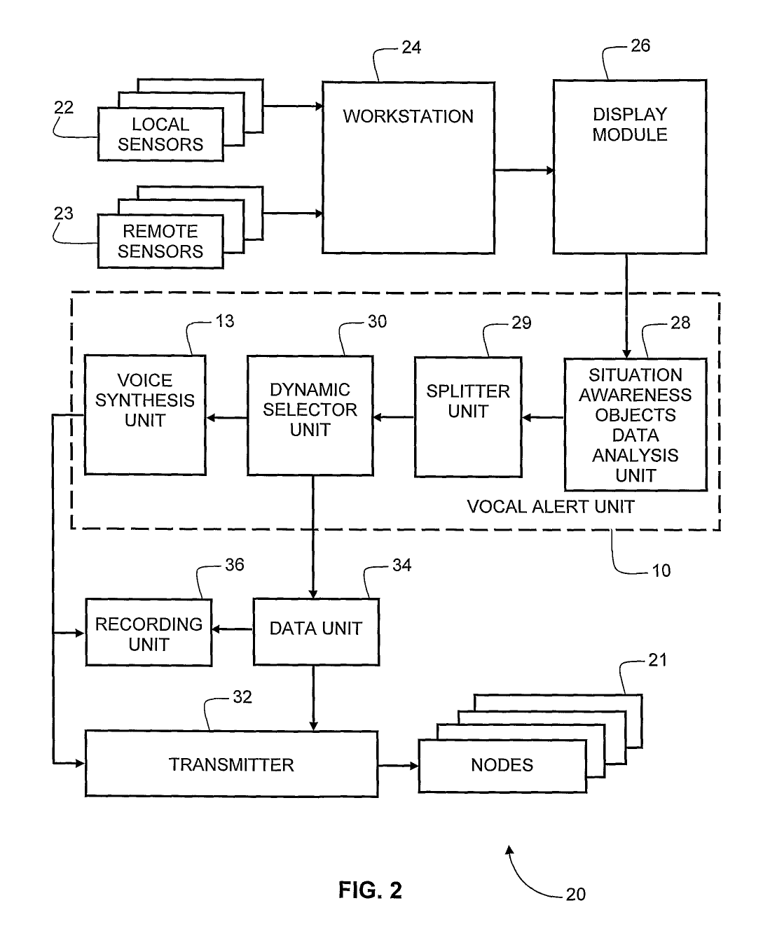

FIG. 2 shows in greater detail an aircraft command, control, communication and intelligence system 20 employing the vocal alert unit 10 shown in FIG. 1, wherein like components will be referred to by identical reference numerals. The system 20 includes a plurality of sensors which receive data from participating aircraft 21 (constituting dynamic nodes) and other objects (including both static nodes and dynamic nodes) in space (constituting a monitored environment). The sensors include local sensors 22, such as radars, optical means etc. and remote sensors 23. The remote sensors may include analog sensors that are coupled to the system via suitable modems, but the distinction between the local and remote sensors is not important so far as the present invention is concerned. The received data depicting an instantaneous location of each node in space traversed by the dynamic nodes is decoded and transferred to a workstation computer 24, where it is fused and integrated so as to produce an integrated scene providing instantaneous situation awareness. The concept of fusing signals form multiple sensors so as to provide a composite picture of mobile and stationary objects is known per se. For example, the airport integrated hazard response apparatus described in above-mentioned U.S. Pat. No. 5,557,278 collects and fuses data from disparate sensors. Such sensors can include, for example, an airport surface detection equipment (ASDE) system that is adapted to provide high-resolution, short-range, clutter-free, surveillance information on aircraft and ground vehicles, both moving and fixed, located on or near the surface of airport movement and holding areas under all weather and visibility conditions. An ASDE system formats incoming surface detection radar information for a desired coverage area, and presents it to local and ground controllers on high-resolution, bright displays in the airport control tower cab. Likewise, an Automated Radar Terminal System (ARTS) may be used for detecting and tracking many aircraft within a large volume of airspace. Other sensors may include a secondary surveillance radar (SSR), global positioning system (GPS). The manner in which such disparate sensor signals are fused is not itself a feature of the present invention and reference is made to U.S. Pat. No. 5,557,278, whose contents are incorporated herein by reference and provide an example of how this may be done.

Within the context of the present invention, the term “situation” is used to denote the composite picture pertaining to a single node, and the term “situation awareness” is used to denote dynamic situations relating to a node relative to other nodes based on specified criteria. To derive such dynamic situations, the system accesses a database of stored criteria each defining a situation that must be avoided or in respect of which special action must be taken. These criteria may be:
is this node on a collision course with another node?
is this node on a collision course with a closed area?

The database also stores data relating to each node in the system, both static and dynamic. These data include a unique ID as well as conditions or other parameters that effect a respective situation computed for the node. For example, a node may be permitted to enter airspace defined by first specified boundary coordinates while being prohibited from entering airspace defined by second specified boundary coordinates. The database may be distributed among many different computers so that the data relating to different nodes need not be stored in a single repository; and indeed even the data relating to a single node may be distributed among different computers.

The situation and conditions of each node is analyzed relative to all criteria in the database to establish for each node whether it answers any of the criteria, in which case special action must now be taken. Likewise, dedicated tasks may be defined on-the-fly that need to be taken owing to a particular situation as determined. For example, interception between an interceptor and a hostile target must take into consideration target characteristics, dynamic, static etc., radar type. The database also includes default data that is used if no superseding data are transmitted by hostile target.

Once having assigned a mission, like intercept, to an aircraft object, the system keeps monitoring changes in the mission data and related objects data, like sudden changes in target heading, velocity etc. and enables to keep the mission assigned object/node up to date. Constantly monitoring the situation picture and using sets of predefined rules of object behavior provides the ability to detect flight corridor or flight plan deviation as well as collision hazards, intrusion alerts or sudden occurring threats etc. and to automatically react accordingly by generating the relevant alert/message to the relevant node.

The fused data are sorted and transferred to a display module 26, which displays the instantaneous situation awareness. The sorting allows data to be organized according to predetermined criteria, such as priority, sensor reliability and so on so as to allow preference to be given to some signals or sensors. But the manner in which this is done is not essential to carrying out the present invention. Situation awareness is a display of the air situation, also known in the art as Air Situation Picture (ASP) and is presented to the controller, usually as a screen picture that is continually recalculated and refreshed.

The situation awareness data is conveyed to a situation awareness objects data analysis unit 28, which performs an analysis of the relations between all objects in the monitored environment so as to assess their significance and to determine threat evaluation. The manner in which threat evaluation is determined is not itself a feature of the present invention, although it will be appreciated that since object kinematics and geographic position are known to the system and are part of the objects managed data, data such as relative bearing, range, altitude, velocity, acceleration etc. are easily calculated. This enables the system to create exact direction/range etc. directives to an intercept mission assigned aircraft towards its target or landing directives to a required landing field.

The analyzed data are fed to a splitter unit 29, which screens and sorts the data according to the various predefined nodes so as to compile situation awareness and threat evaluation data pertaining to each node separately. These data are conveyed to a dynamic selector unit 30, which controls the distribution of the processed data to the various nodes 21 and generates command data in alphanumeric format that is conveyed to the respective aircraft for display on the pilot's screen. The voice synthesis unit 13 (shown in FIG. 1) is coupled to the dynamic selector unit 30 for converting the alpha-numeric command data to speech format. Alternatively, alphanumeric command data may be conveyed to the aircraft and converted to speech commands by a voice synthesis unit on-board the aircraft.

In the case that a voice synthesis unit is provided as part of the vocal alert unit, the system controller may select in what format to transmit the relevant data to the various nodes by means of a transmitter 32. Thus, he can opt to issue commands vocally via a microphone (not shown) fed to a data unit 34, which produces a digitized voice signal that is then transmitted by the transmitter 32. Although this is the manner in which commands are typically conveyed in C4I systems, it is unreliable and time consuming. The dynamic selector unit 30 may therefore be set to route command data to the voice synthesis unit 13 so as to produce synthetic speech which is directly transmitted in digital form by the transmitter 32. In either case, command data in either digitized vocal or voice synthesized formats may be recorded by a recording unit 36 for subsequent replay.

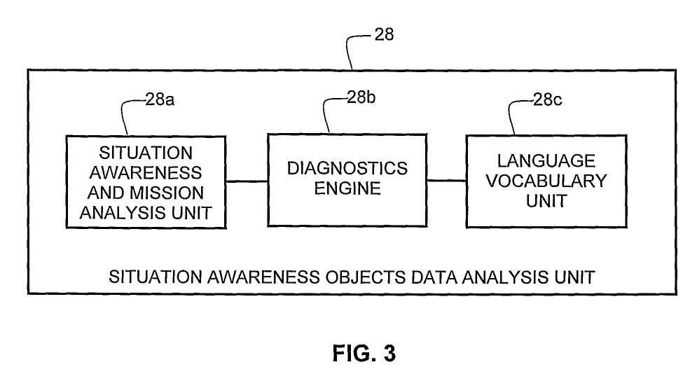

FIG. 3 is a block diagram showing in more detail the functionality of the situation awareness objects data analysis unit 28. A situation awareness and mission analysis unit 28a keeps track and manages all objects that are part of the situation picture and analyzes all threats and/or mission relationships associated therewith as defined by the human controller. As noted above, these may include intercept, landing, collision avoidance etc. A diagnostics engine 28b converts the analyzed data into scheduled sequences of logical data sentences containing intercept, landing, warning directives, etc. to be transmitted to the various participants. A language vocabulary unit 28c converts logical data sentences into human language sentences, in any predefined language text, to be later synthesized and transmitted to the participants via commercial off the shelf Text-to-Speech engines. Typically the messages are formed of command primitives that serve as templates that may be customized according to circumstance by concatenating several command primitives with auxiliary data such as trajectory to be pursued by a target node or ID, location, trajectory and so on of a node that is to be intercepted or avoided. Thus, while messages are based on pre-stored primitives, they are actually constructed in real time according to current, dynamically changing, data. Moreover, the messages are personalized for each receiving node in a manner analogous to manual systems where a human controller conveys vocal messages to each recipient individually.

It should be noted that although commands are formulated by the situation awareness objects data analysis unit 28 they need not be voice-synthesized by the vocal alert unit. Thus, an alternative approach is to convey data to each node that allows voice synthesis to be performed locally by each receiving node. Likewise, it is technically feasible to convey the raw primitives and auxiliary data to the respective receiving nodes, so as to allow them to construct and voice-synthesize the command.

It will also be appreciated that the sensors are not part of the vocal alert unit but are external sensors such as radar, SSR and GPS sensors which are provided as standard in air-traffic control systems. Thus it is sufficient that the vocal alert unit have inputs for coupling the sensors thereto.

It will also be understood that while the invention has been described with particular regard to an air-traffic controller system that reduces the load on the human controller and, in extreme situations, may even obviate the need for a human controller as suggested in EP 1 190 408, in fact the invention finds much more general application. Thus, it can be used in any of the scenarios described in the patents cited in the background section all of whose contents are incorporated herein by reference. By way of simple example, the same principles are applicable in a taxi dispatch system. For example, an advanced taxi dispatch system may keep track of potential fares and schedule the nearest available taxi to pick up a fare. However, unlike known systems, movement of the fare can also be tracked: for example via a GPS unit carried on his or her person, or even via a mobile telephone whose location in space can be determined with reasonable accuracy. This allows the controller to inform the selected taxi driver exactly where to pick up the fare. But more than this, if the fare moves prior to being picked up, possibly because he thinks it will be more convenient for the driver, his or her updated location will be constantly conveyed to the controller and then relayed vocally to the driver. The driver is thereby constantly updated how to maneuver in order to carry out the target mission of meeting the destined fare. But this is done in such a manner as to reduce the load on the human dispatcher, since the updating is processed and conveyed automatically.

Many other applications will, of course, be apparent to those skilled in the art.

Integration of the voice synthesis unit 13 within the vocal alert unit 10 gives rise to a C4I system having the following advantages:
High reliability since human errors in reading of digital data and converting it into speech are avoided.
Simultaneous operation since the vocal alert unit 10 is capable of generating and transmitting command data to a plurality of aircraft or other nodes substantially simultaneously. This is impossible when a human controller issues command data verbally.
Rate of data refreshment may vary.
Command data may be generated and conveyed in any language.
Command data may optionally be transmitted using different voices, such as male/female, high/low pitch, slow/fast speech etc.
Since threat analysis, determination and vocalization of suitable evasive action are all automated, the system controller is relieved to attend to other matters.
Mental stress on the system controller is thereby reduced.

It will be understood that the vocal alert unit 10 may be used in all types of C4I system including civil, military, or paramilitary, such as take off or landing systems in airports, aircraft carriers, Airborne Warning And Control Systems (AWACS), maritime, as well as terrestrial based C4I systems, requiring high concentration and fast response from the controllers.

Although in the exemplary embodiments, personalized messages are vocalized, the principles of the invention may be applied also to the rendering of personalized messages in other forms, such as visually or possibly both vocally and visually.

It will also be understood that the system according to the invention may be a suitably programmed computer. Likewise, the invention contemplates a computer program being readable by a computer for executing the method of the invention. The invention further contemplates a machine-readable memory tangibly embodying a program of instructions executable by the machine for executing the method of the invention.

1. A method for instructing dynamic nodes in a dynamically changing mobile network how to maneuver in order to carry out a target mission or of evasive action they should perform to maneuver out of a path of a perceived threat, said method comprising:
receiving situation data indicative of a respective situation of each dynamic node in space;
determining from said situation data the respective situation of each dynamic node;
analyzing the respective situation of each dynamic node in combination with specified criteria to generate respective situation awareness data for each dynamic node;
determining from the respective situation awareness data appropriate action to be performed by each node; and
conveying to the respective dynamic node command data to permit rendering of a personalized command for informing the respective node of appropriate action to be carried out thereby.

2. The method according to claim 1, wherein the situation data is further indicative of static nodes in the network.

3. The method according to claim 1, wherein the personalized command is rendered vocally at each node.

4. The method according to claim 3, including:
converting the situation awareness data into scheduled sequences of logical data sentences containing suitable directives; and
converting said sequences of logical data sentences into human language sentences for voice-synthesizing by a text-to-speech engine.

5. The method according to claim 4, wherein converting said sequences of logical data sentences into human language sentences includes concatenating command primitives with auxiliary data.

6. The method according to claim 4, including voice-synthesizing the human language sentences prior to transmitting to the respective nodes.

7. The method according to claim 4, including transmitting the human language sentences to the respective nodes in text format for vocalizing by the respective nodes.

8. The method according to claim 5, wherein a characteristic language is associated with at least one of the nodes and the sequences of logical data sentences are converted into human language sentences in said characteristic language.

9. The method according to claim 1, wherein said command data is representative of the constructed personalized command and there is further included using the command data to construct said personalized command.

10. The method according to claim 1, wherein the situation awareness data is indicative of a perceived threat to the respective node and the command data relates to evasive action that should be performed by the respective node.

11. The method according to claim 1, including:
converting the situation awareness data into scheduled sequences of logical data sentences containing suitable directives; and
converting said sequences of logical data sentences into human language sentences.

12. The method according to claim 11, wherein converting said sequences of logical data sentences into human language sentences includes concatenating command primitives with auxiliary data.

13. The method according to claim 11, including transmitting the human language sentences in text format for display by the respective nodes.

14. A system (20) for instructing dynamic nodes in a dynamically changing mobile network how to maneuver in order to carry out a target mission or of evasive action they should perform to maneuver out of a path of a perceived threat, said system comprising:
a receiver (22, 23) for receiving situation data indicative of a respective situation of each dynamic node in space;
a situation unit (24) coupled to the receiver for determining from said situation data the respective situation of each dynamic node;
an analysis unit (28) coupled to the situation unit for analyzing the respective situation of each dynamic node in combination with specified criteria to generate respective situation awareness data for each dynamic node;
a dynamic selector unit (30) coupled to the analysis unit for determining from the respective situation awareness data appropriate action to be performed by each node; and
a communication unit (32) coupled to the dynamic selector unit for conveying to the respective dynamic node command data to permit rendering of a personalized command for informing the respective node of appropriate action to be carried out thereby.

15. The system according to claim 14, wherein the situation data is further indicative of static nodes in the network.

16. The system according to claim 14, wherein the personalized command is rendered vocally at each node.

17. The system according to claim 16, including:
a diagnostics engine (28b) for converting the situation awareness data into scheduled sequences of logical data sentences containing suitable directives; and
a language vocabulary unit (28c) coupled to the diagnostics engine for converting said sequences of logical data sentences into human language sentences.

18. The system according to claim 17, wherein the diagnostics engine is adapted to concatenate command primitives with auxiliary data.

19. The system according to claim 17, wherein a voice synthesis unit (13) is coupled to the language vocabulary unit for voice-synthesizing the human language sentences.

20. The system according to claim 17, wherein the language vocabulary unit generates the human language sentences in text format.

21. The system according to any claim 18, wherein the diagnostics engine is responsive to a characteristic language associated with at least one of the nodes for converting the sequences of logical data sentences into human language sentences in said characteristic language.

22. The system according to claim 14, wherein the dynamic selector unit is adapted to use the command data to construct said personalized command.

23. The system according to any claim 14, wherein the situation awareness data is indicative of a threat to the respective node and the command data relates to evasive action that should be performed by the respective node.

24. The system according to claim 14, including:
a diagnostics engine (28b) for converting the situation awareness data into scheduled sequences of logical data sentences containing suitable directives; and
a language vocabulary unit (28c) coupled to the diagnostics engine for converting said sequences of logical data sentences into human language sentences.

25. The system according to claim 24, wherein the diagnostics engine is adapted to concatenate command primitives with auxiliary data.

26. The system according to claim 24, wherein the language vocabulary unit generates the human language sentences in text format.

27. The system according to any claim 14, wherein the dynamic nodes include aircraft

28. The system according to any claim 14, wherein the receiver has inputs for coupling to external sensors such as radar, SSR and GPS sensors.

29. A computer program product comprising a computer useable medium having computer readable program code embodied therein for instructing dynamic nodes in a dynamically changing mobile network how to maneuver in order to carry out a target mission or of evasive action they should perform to maneuver out of a path of a perceived threat, said computer program product comprising:
computer readable program code for causing the computer to receive situation data indicative of a respective situation of each dynamic node in space;
computer readable program code for causing the computer to determine from said situation data the respective situation of each dynamic node;
computer readable program code for causing the computer to analyze the respective situation of each dynamic node in combination with specified criteria to generate respective situation awareness data for each dynamic node;
computer readable program code for causing the computer to determine from the respective situation awareness data appropriate action to be performed by each node; and
computer readable program code for causing the computer to convey to the respective dynamic node command data to permit rendering of a personalized command for informing the respective node of appropriate action to be carried out thereby.
